(19) United States
(12) Patent Application Publication
(10) Pub. No.: US 2025/0272327 A1
(43) Pub. Date: Aug. 28, 2025

(54) Systems and Methods for Data-Driven Query and Response Searching

(71) Applicants: Yauheni Padaliak, Hawthorn Woods, IL (US); William Stephen Flannery, Plainsboro, NJ (US); Ronald Burton Edgecomb, II, Toms River, NJ (US); Mikalai Krapivin, West Windsor, NJ (US); Brynn James McCormick, Toms River, NJ (US); Aliaksandr Autayeu, Amsterdam (IT)

(72) Inventors: Yauheni Padaliak, Hawthorn Woods, IL (US); William Stephen Flannery, Plainsboro, NJ (US); Ronald Burton Edgecomb, II, Toms River, NJ (US); Mikalai Krapivin, West Windsor, NJ (US); Brynn James McCormick, Toms River, NJ (US); Aliaksandr Autayeu, Amsterdam (IT)

(21) Appl. No.: 18/971,917

(22) Filed: Dec. 6, 2024

Related U.S. Application Data
(60) Provisional application No. 63/607,895, filed on Dec. 8, 2023.
(60) Provisional application No. 63/607,891, filed on Dec. 8, 2023.

(51) Int. Cl. G06F 16/335; G06F 16/35

(52) U.S. Cl. CPC G06F 16/335; G06F 16/35

(57) ABSTRACT

A system and method are provided for automatic query and response generation. The method may include obtaining a query log of historical queries within a predetermined knowledge domain. The method may also include clustering the query log to identify one or more sets of queries using semantic aggregation. The method may also include generating one or more responses for each of the one or more sets of queries using a large language model. The responses may be within the predetermined knowledge domain. The method may also include receiving feedback data for each of the one or more responses. The feedback data may identify a preferred response. The method may also include, in response to receiving a new query, providing a new response to the new query. The new response may be a preferred response for a set of queries including the new query.

### CROSS-REFERENCE TO RELATED APPLICATIONS

This application claims benefit under 35 U.S.C. § 119(c) to U.S. Provisional App. Ser. No. 63/607,895, filed Dec. 8, 2023, entitled “Systems and Methods for Data-Driven Query and Response Searching” and U.S. Provisional App. Ser. No. 63/607,891, filed Dec. 8, 2023, entitled “Systems and Methods for Data-Driven Query and Response Generation,” the disclosure of each of which is incorporated by reference herein in its respective entirety.

### TECHNICAL FIELD

This application relates generally to knowledge query systems, and more specifically to domain-specific natural language query and response systems.

### BACKGROUND

Some current knowledge-based search systems provide sets of search results including documents related to a search query. Although such systems may provide large sets of responsive documents, such systems may not be trustworthy and/or reliable. In addition, these platforms are not capable of generating responses that correspond to a complexity of a request. For example, research complexity can vary. Simple research, which may be frequent, may take roughly 5 to 10 minutes to complete, and may be handled by staff and managers. This may include, for example, a fact and/or figure look-up via a search engine, or a research software tool. Such research may not require collaboration or interpretation. On the other hand, complex research, even if infrequent, may take 30 to 60 minutes to a half day or up to several days to complete. Such research may need to be handled by senior personnel with domain knowledge and expertise. In some instances, an organization may not have the right experts to response a specific query. For example, users may have queries regarding unique tax scenarios, such as nuanced industry and/or geography, pertaining to ambiguous areas of tax code. Although some current search platforms utilize complex technologies, such as generative artificial intelligence (AI), products, services and expert solutions need to be based on a foundation of trust and transparency.

### SUMMARY

In some embodiments, a method for automatic response generation and searching is disclosed. The method may include obtaining a query log of historical queries within a predetermined knowledge domain. The method may also include clustering the query log to identify one or more sets of queries using semantic aggregation. The method may also include generating one or more responses for each of the one or more sets of queries using a large language model. The responses may be within the predetermined knowledge domain. The method may also include receiving feedback data for each of the one or more responses. The feedback data may identify a preferred response. The method may also include in response to receiving a new query, providing a new response to the new query. The new response may be a preferred response for a set of queries including the new query.

In some embodiments, the method further includes, prior to receiving feedback data, prioritizing the one or more responses, based on frequency of queries in the query log.

In some embodiments, the method further includes, prior to generating one or more responses, prioritizing the one or more sets of queries, based on frequency of queries in the query log.

In some embodiments, the method further includes associating one or more queries with the one or more responses based on the feedback data.

In some embodiments, the method further includes receiving queries based on keywords obtained from the one or more sets of queries, and/or generating the one or more responses based on the received queries.

In some embodiments, the method further includes highlighting sources used for generating queries for receiving feedback data for each of the one or more responses.

In some embodiments, the method further includes after a first query is selected, preloading one or more queries related to the first query. The first query may be based on the feedback data. The one or more queries may be generated using a large language model and/or semantic aggregation.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide curated, domain-specific, natural language search results, in accordance with some embodiments;

FIG. 2 illustrates a computer system configured to implement one or more processes, in accordance with some embodiments;

FIG. 3 is a flowchart illustrating a domain-specific search process, in accordance with some embodiments;

FIG. 4 illustrates a knowledge-domain search interface, in accordance with some embodiments;

FIG. 5 illustrates a domain-specific query-response interface, in accordance with some embodiments;

FIG. 6 illustrates a domain-specific query-response interface, in accordance with some embodiments;

FIG. 7 illustrates a knowledge-domain query-response interface, in accordance with some embodiments;

FIG. 8A illustrates a knowledge-domain search interface, in accordance with some embodiments;

FIG. 8B illustrates another view of the knowledge-domain search interface shown in FIG. 8A, in accordance with some embodiments;

FIG. 9 illustrates a query-response association interface, in accordance with some embodiments;

FIG. 10 is a system diagram of an example query and/or response generation system, in accordance with some embodiments;

FIG. 11 is a flowchart for an example method for automatic query and response generation, in accordance with some embodiments; and

FIG. 12 is a schematic diagram of an example process for clustering and/or semantic aggregation, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Various embodiments are described herein with respect to systems and methods for providing curated, natural language, knowledge-based search results. In some embodiments, generative AI models may be configured to generate textual content elements, such as, for example, responses that may be provided in response to one or more queries. The generative AI models may create and/or curate responses to the one or more queries based on a limited knowledge-domain corpus, such as, for example, a set of one or more documents within a predetermined knowledge domain. Queries may be clustered and at least one preferred response may be associated with each of the clusters of queries. When a search query is received from a user, the query is associated with a cluster and the preferred response associated with the cluster is returned. Data sources may include text content (e.g., books, journals, etc.), structured data sources (e.g., practice tools, drug databases, etc.), and/or customer data (e.g., accounting records, etc.).

In some embodiments, feedback data may be used to select or prioritize one or more queries and/or responses that are more likely to have a maximum impact for customers. In some embodiments, historical queries included in a query log are clustered to identify common or similar queries. The historical queries may include, but are not limited to, historical user queries, queries created based on keywords, queries generated by one or more generative AI models, etc. The disclosed systems and methods utilize clustering to provide domain-specific, curated, applicable AI generated responses to knowledge-domain queries.

In some embodiments, search history is analyzed to determine trends in queries, most popular queries, and/or popular query clusters. A goal of the system described herein may be to provide a reusable implementation for common query and/or response user interaction patterns, data sources, and/or supervision models. The system may be configured to integrated feedback data such as editorial review, approval of queries and/or responses, and/or community feedback (e.g., thumbs up/down). Some embodiments may include unsupervised learning (e.g., automatic, continuous and/or intermittent learning from user query logs).

In some embodiments, when a search portal is visited and a query is posed, instead of (or in addition to) returning documents (e.g., top ten documents), a generated interface includes a natural language response to the query. The response may include a narrative text element providing summarized information responsive to the query. The response may be generated at least partially by a generative AI.

In some embodiments, semantically similar queries are clustered based on semantic aggregation. Beyond basic aggregation that may be performed in an SQL server, to aggregate identical things, strings, or concepts, some embodiments perform semantic aggregations to create clusters of queries and/or prioritize the queries. Clustering is described below in reference to FIG. 15, in accordance with some embodiments.

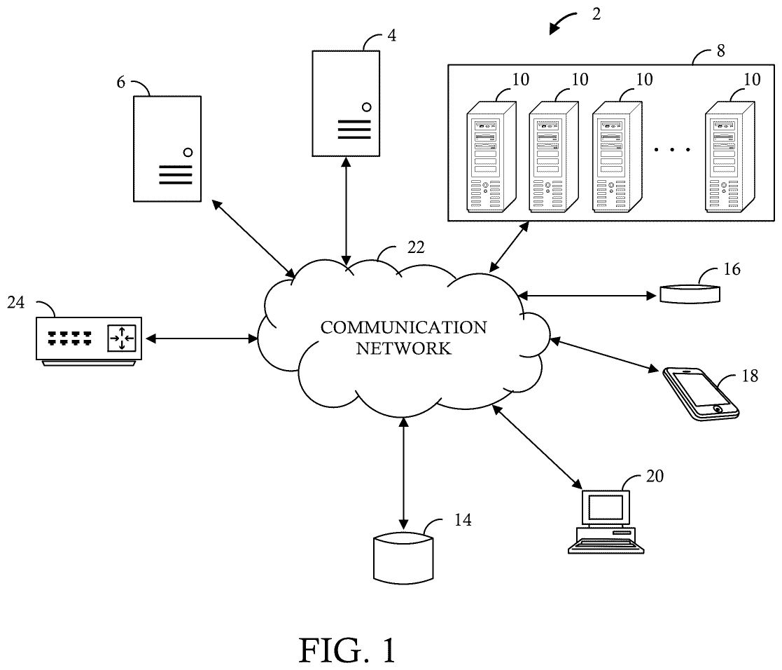

FIG. 1 illustrates a network environment 2 configured to provide curated, domain-specific, natural language search responses, in accordance with some embodiments. The network environment 2 includes a plurality of devices or systems configured to communicate over one or more network channels, illustrated as a network cloud 22. For example, in various embodiments, the network environment 2 may include, but is not limited to, a domain-specific search computing device 4, a web server 6, a cloud-based engine 8 including one or more processing devices 10, a database 14, and/or one or more user computing devices 16, 18, 20 operatively coupled over the network 22. The domain-specific search computing device 4, the web server 6, the processing device(s) 10, and/or the user computing devices 16, 18, 20 may each be a suitable computing device that includes any hardware or hardware and software combination for processing and handling information. Each computing device may transmit and receive data over the communication network 22.

In some embodiments, each of the domain-specific search computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the domain-specific search computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as a knowledge-based network environment. In some embodiments, the domain-specific search computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the domain-specific search computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the domain-specific search computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view data for elements associated with and displayed on the website, and click on interface elements presented via the website. The website may capture these activities as user session data, and transmit the user session data to the domain-specific search computing device 4 over the communication network 22. The website may also allow the user to interact with one or more of interface elements to perform specific operations, such as selecting one or more elements for further processing.

In some embodiments, the domain-specific search computing device 4 may execute one or more models, processes, or algorithms, such as a machine learning model, deep learning model, statistical model, etc., to identify, retrieve, and/or display curated, natural language response. The domain-specific search computing device 4 may transmit one or more selected, curated responses to the web server 6 over the communication network 22, and the web server 6 may display interface elements associated with the curated responses on the website to the user.

The domain-specific search computing device 4 is further operable to communicate with the database 14 over the communication network 22. For example, the domain-specific search computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the domain-specific search computing device 4, in some embodiments, the database 14 may be a local storage device, such as a hard drive, a non-volatile memory, or a USB stick. The domain-specific search computing device 4 may store interaction data received from the web server 6 in the database 14. The domain-specific search computing device 4 may also receive from the web server 6 user session data identifying events associated with browsing sessions, and may store the user session data in the database 14.

In some embodiments, the domain-specific search computing device 4 assigns portions of one or more processes for execution to one or more processing devices 10. For example, each process may be assigned to a virtual machine hosted by a processing device 10. The virtual machine may cause the processes or parts thereof to execute on one or more processing units such as GPUs. In some embodiments, the virtual machines assign each process (or part thereof) among a plurality of processing units. Based on the output of the processes, domain-specific search computing device 4 may generate curated, natural language responses.

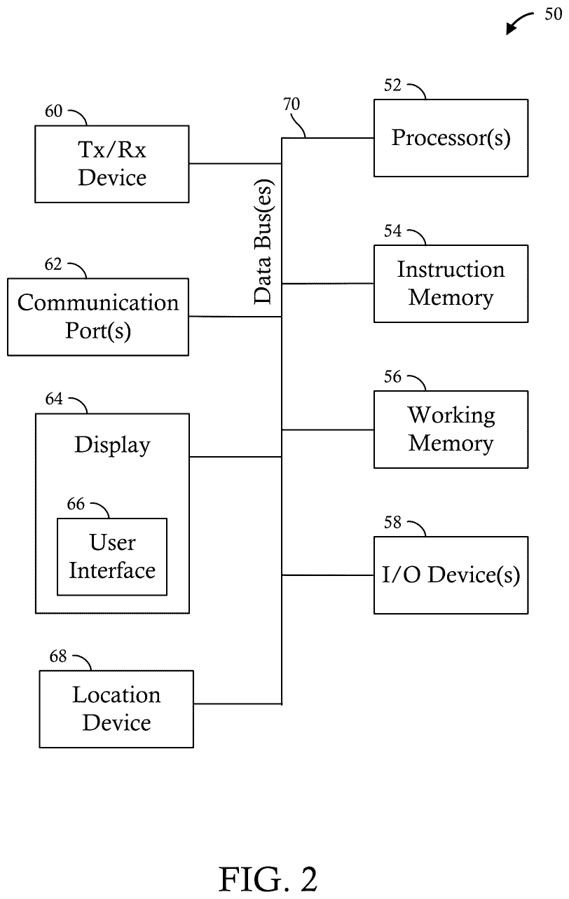

FIG. 2 illustrates a block diagram of a computing device 50, in accordance with some embodiments. In some embodiments, each of the domain-specific search computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for identifying and/or presenting curated, knowledge-based, natural language responses, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with [DESCRIPTION]. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

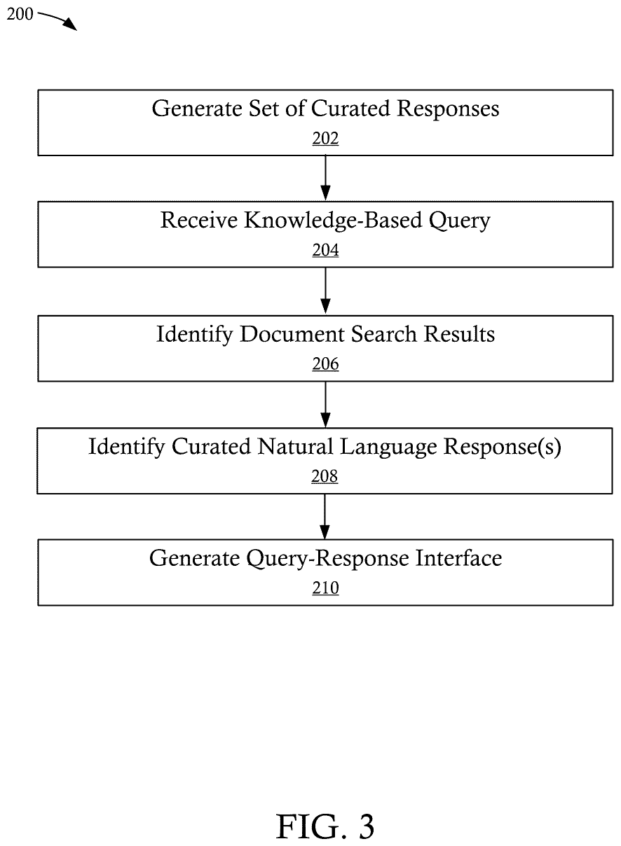

FIG. 3 is a flowchart illustrating a domain-specific search process 200, in accordance with some embodiments. At step 202, a set of curated responses is generated. Each response in the set of curated responses includes a text-based, natural language response to a knowledge-based query. The curated responses may include responses generated, at least in part, by generative AI models and approved or revised based on received feedback data. For example, in some embodiments, a plurality of responses may be generated, at least in part, by a generative AI model configured to operate within a predetermined set of documents related to a predetermined knowledge-domain. Generated responses may be selected as curated responses, at least in part, based on feedback received from one or more feedback sources, such as user interactions, reviewer interactions, etc.

In some embodiments, each of the responses in the set of curated responses is associated with at least one of a plurality of query clusters. Query clusters include clusters, or sets, of queries that are grouped (e.g., clustered) together. The query clusters may include semantically similar queries and/or topically similar queries identified by a semantic aggregation clustering process. As discussed in greater detail below, in some embodiments, the query clusters include clusters of historical and/or generated queries.

In some embodiments, each query includes at least one preferred response associated therewith. A preferred response may include a response configured to provide a highest level of engagement (e.g., a response having accurate information that is presented in a concise manner and that is responsive to the corresponding query). Preferred responses may be determined based on feedback, such as, for example, user interaction feedback, reviewer feedback, etc.

In some embodiments, a set of curated queries and associated responses may be generated from one or more documents in a corresponding knowledge domain. For example, in some embodiments, a large language model is configured to generate one or more queries and/or one or more responses within a knowledge domain based on the content of one or more documents. Generative AI may be used to generate queries and/or responses based on similarity between prior queries and/or responses and/or based on feedback to prior queries and/or responses. A trained machine learning model (e.g., large language model (LLM), generative AI, etc.) configured to generate responses, as provided herein, may be trained and/or limited to specific knowledge domains and/or documents such that queries and/or responses are generated only from trusted (e.g., known) content, increasing the probability that generated queries and/or responses may be trusted and/or approved. This will also simplify editing and/or reviewing. For example, instead of scrolling through the top ten documents and analyzing them one by one, a system may present meaningful, pre-generated preferred responses and receive feedback data for modifying and/or classifying the pre-generated responses.

At step 204, a knowledge query is received. The knowledge query includes a text-based query (e.g., natural language question) configured to identify specific knowledge selected from a predetermined knowledge domain. A knowledge query may include a query to identify specific knowledge or content within one or more of a tax domain, a finance domain, a legal and/or regulatory domain, a health domain, a corporate governance domain, etc. As one non-limiting example, in some embodiments, a query within a tax knowledge domain may be related to specific tax codes, specific tax requirements, etc.

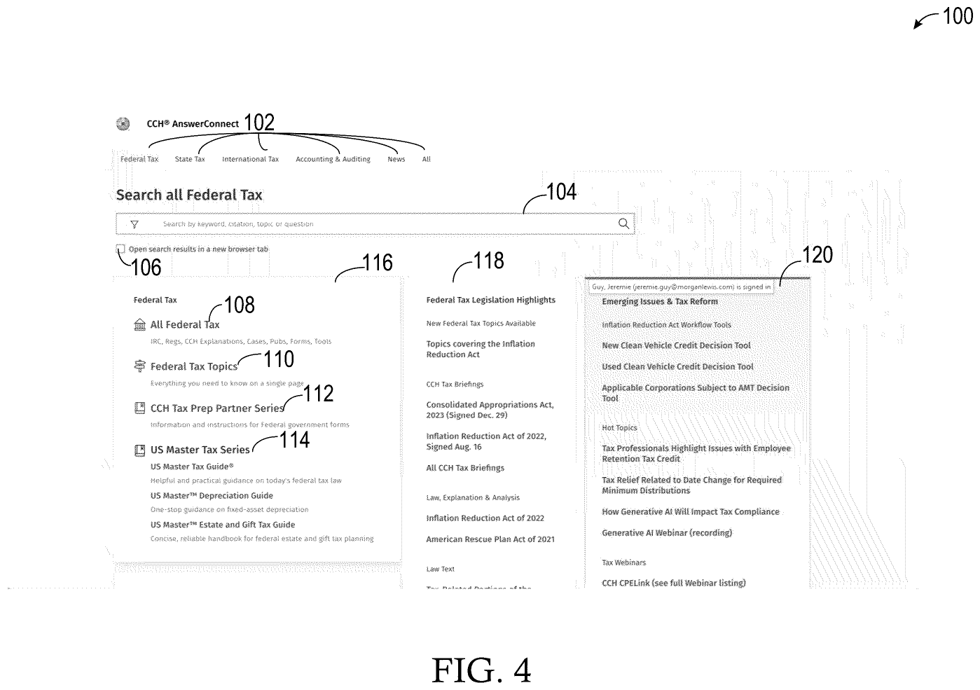

FIG. 4 illustrates a query interface 100, in accordance with some embodiments. The interface 100 may include tabs 102 corresponding to different sub-domains within one or more knowledge domains (e.g., the illustrated interface includes one or more sub-domains of a tax domain including federal tax, state tax, international tax, accounting and auditing, etc.). A search box 104 may be configured to receive textual input, such as a query for content related to a selected knowledge domain. Searching may be performed by keyword, citation, topic, query, etc. Search results may be opened in a new browser tab (e.g., by selecting the option 106). Hyperlinks (e.g., links 108, 110, 114) to sub-topics may be shown (e.g., under the search box). Different panes (e.g., panes 116, 118 and 120) for categories may also be shown (each pane may have a set of hyperlinks). The interface 100 may be used to search for content on a specific topic, but may not provide responses to specific user queries.

With reference again to FIG. 3, at optional step 206, a set of search results including one or more documents is identified based on the knowledge query. The set of search results may include, but are not limited to, documents selected from a set of predetermined documents associated with the knowledge-domain selected for searching by a user (e.g., a tax domain, legal domain, health domain, etc.). The documents may include a set of N documents, where N is a positive integer. The set of documents may be provided in any suitable format, such as a list, a set of interface elements, downloadable documents, etc.

At step 208, a curated response is identified for the received user query. In some embodiments, a received user query is semantically associated with a previously generated and approved query. A vector similarity between a received user query and a set of curated queries may be used to identify a semantically similar curated query. For example, when the received user query is in the set of generated queries, the received user query is associated with the received user query. As another example, when the received user query is not in the set of generated queries, the received user query is associated with a curated query having the highest semantically similarity, e.g., the highest vector similarity. As yet another example, a query may be identified based on keyword searching, keyword similarity, and/or any other suitable process.

After identifying a curated query associated with the received user query, at least one curated response associated with the identified query is selected for inclusion in a query-response interface. For example, in some embodiments, a preferred response associated with the selected query may be obtained. As another example, in some embodiments, each of a plurality of curated responses associated with a selected query may be obtained. It will be appreciated that any suitable number of curated responses may be associated with a query and retrieved for inclusion in a query-response interface.

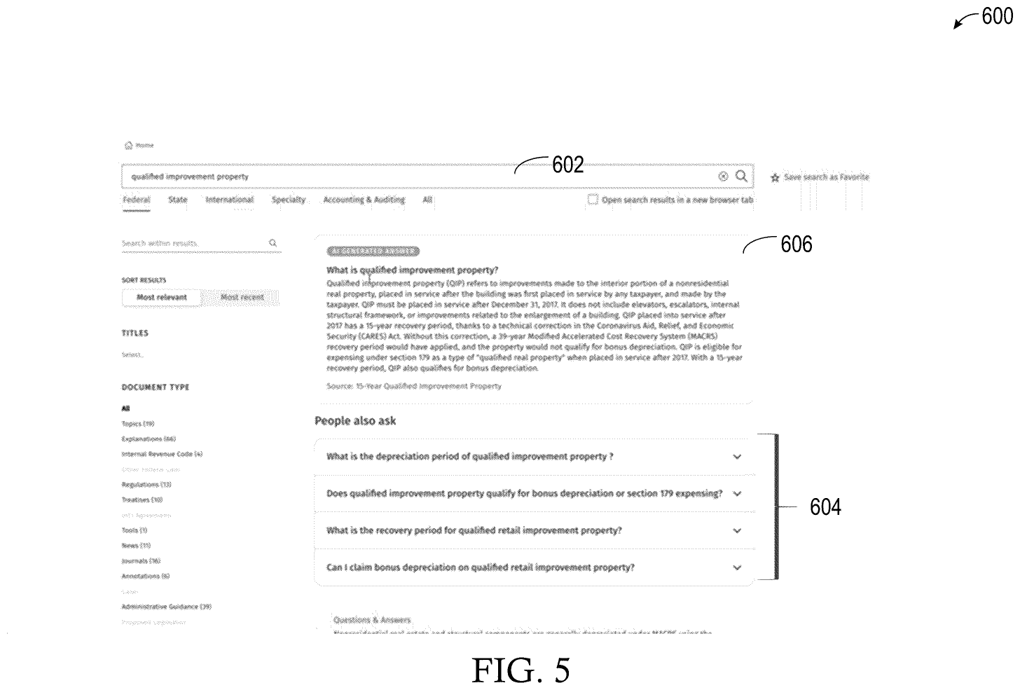

FIG. 5 illustrates a domain-specific query-response interface 600, in accordance with some embodiments. The interface 600 may be presented in response to a query entered in a search box of a query interface 100, such as, for example, as shown in search box 602. In some embodiments, the query-response interface 600 includes at least one curated textual response 606 responsive to a query (e.g., “qualified improvement property”). The query-response interface 600 includes a curated response 606.

At optional step 208, a set of additional queries is identified. The set of additional queries includes similar and/or related queries with respect to the received user query. For example, a set of additional queries may include curated queries selected from within a query cluster associated with the previously selected curated query and/or associated with the previously selected curated query. As another example, a set of additional queries may include one or more queries selected from the next highest semantically similar queries. As yet another example, in some embodiments, additional queries may be selected based on keyword, semantic similarity, and/or any other suitable process. As illustrated in FIG. 5, the similar queries 604 may be provided as part of a query-response interface 600. As previously discussed, each query may include a machine-generated and feedback-approved query.

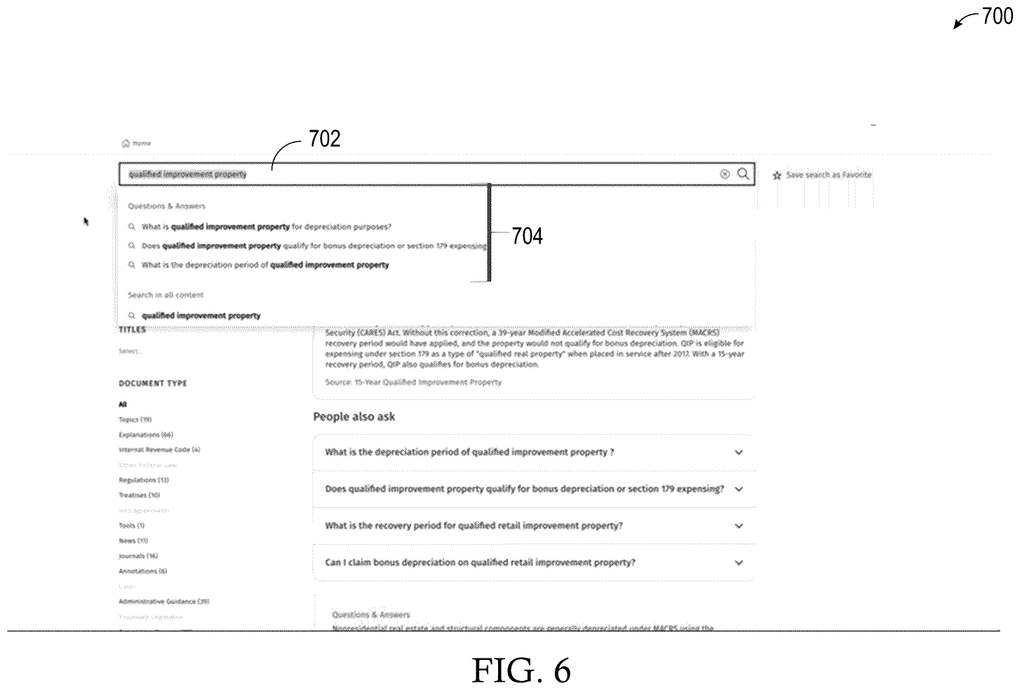

At step 210, a query-response interface is generated including the one or more curated responses and, optionally, the set of additional queries. For example, FIG. 6 illustrates a query-response interface 700, in accordance with some embodiments. In some embodiments, the queries and/or responses are shown as selectable options 704 adjacent to a search box 702 (e.g., instead of having to navigate to a different portion of a screen, the query and/or response options may be provided right below the search box).

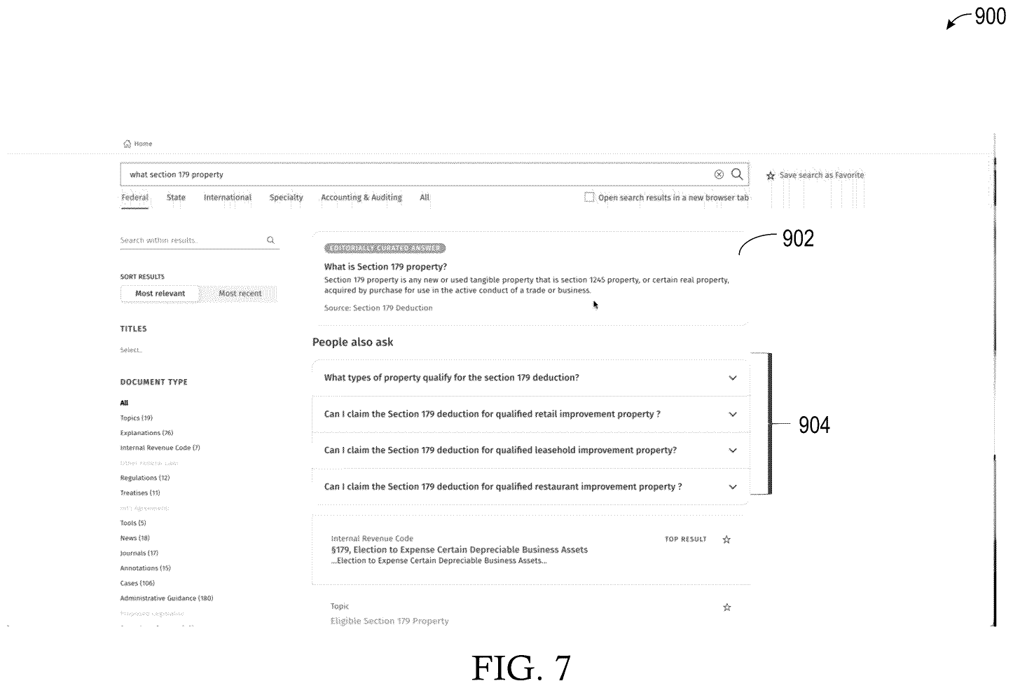

FIG. 7 illustrates a query interface 900, in accordance with some embodiments. In some embodiments, curated and approved responses 902 may be provided. For example, a curated definition for Section 179 property may be provided to a query for “what section 179 property.” In some embodiments, the curated responses may include AI-generated responses. The query interface 900 may further include a set of curated related queries 904, as discussed above with respect to step 208 of FIG. 3. The responses 902 and related queries 904 may be determined dynamically (e.g., responsive to a query), may be predetermined (e.g., prior to receiving queries), and/or may be continuously determined (e.g., in response to selection of queries and/or responses).

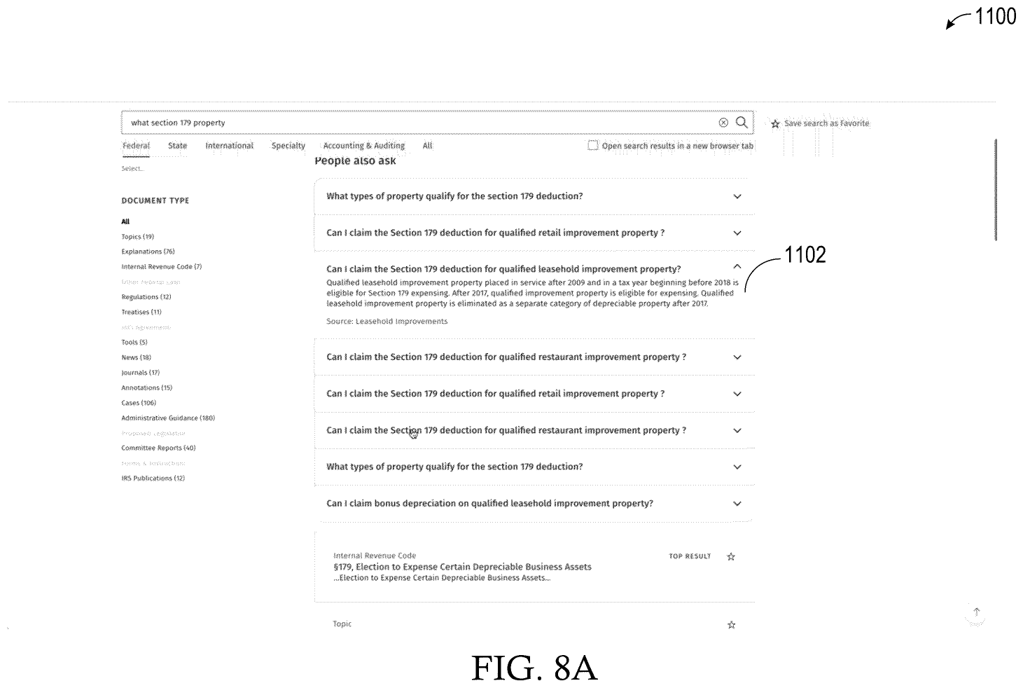

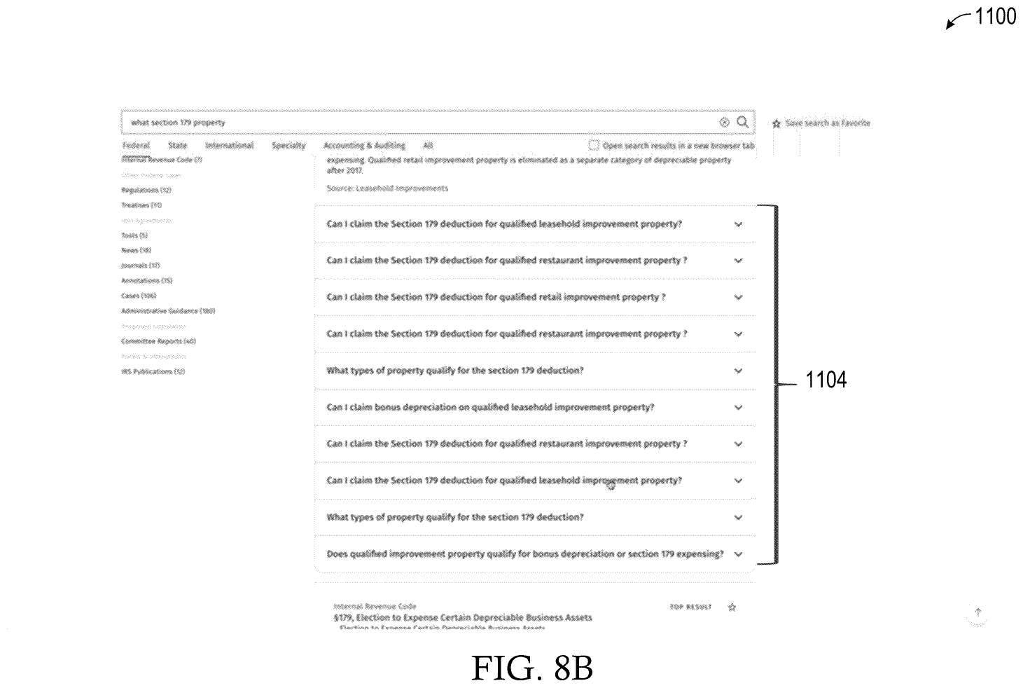

FIG. 8A illustrates a query interface 1100, in accordance with some embodiments. In some embodiments, when a query is selected, additional, related and/or similar queries may be displayed. The example illustrates selection of a query 1102 (“Can I Claim the Section 179 for qualified leasehold improvement property?”). FIG. 8B illustrates another view of the query interface 1100, in accordance with some embodiments. In some embodiments, one or more additional queries may be identified based on user intention determinations, query clusters, semantic grouping, and/or any other suitable process.

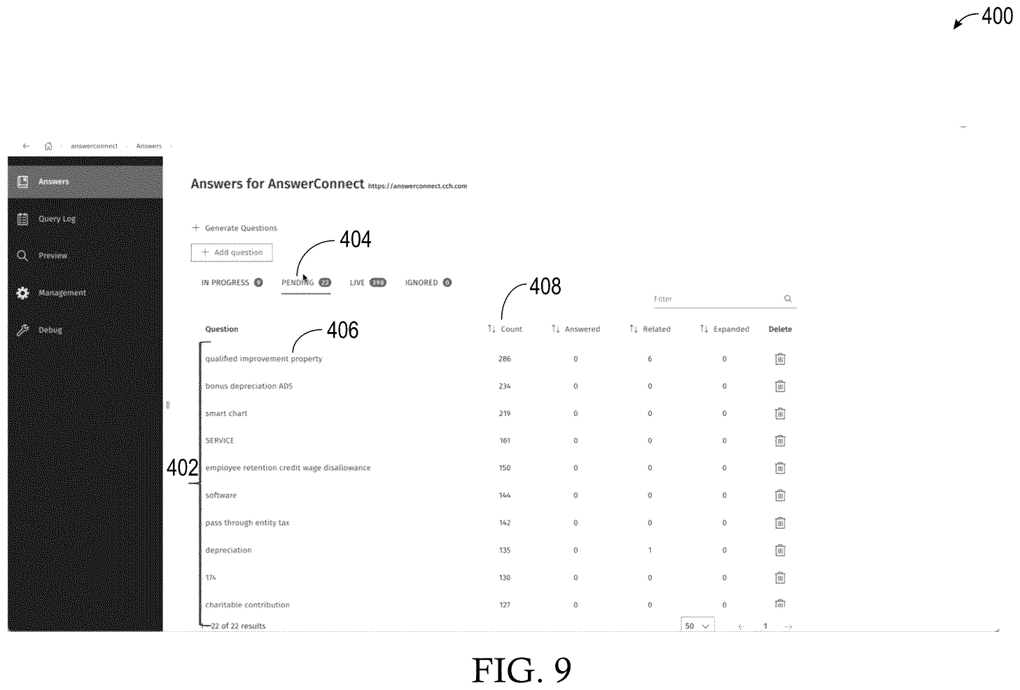

FIG. 9 illustrates a query-response association interface 400 illustrating associations between queries and responses, in accordance with some embodiments. In some embodiments, sets of queries and/or responses may be clustered. The example in FIG. 9 illustrates a cluster 406 for qualified improvement property. Some embodiments show a count 408 of the number of times that a query (and/or a cluster) was searched. This may include a count of searches times a number of months a query and/or a set of queries (e.g., a query cluster) was searched. The counts and/or statistics may be aggregated by the system for different queries.

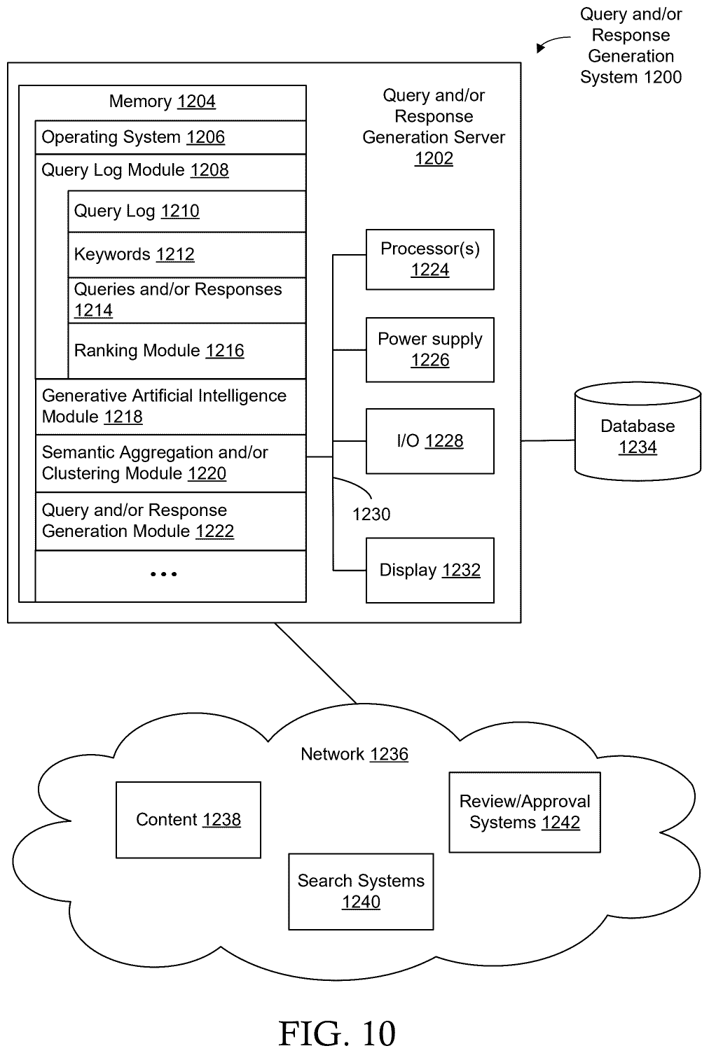

FIG. 10 is a system diagram of an example query and/or response generation server 1200, according to some embodiments. The server 1200 typically includes a query and/or response generation server 1202 that includes one or more processor(s) 1224, a memory 1204, a power supply 1226, an input/output (I/O) subsystem 1228, and a communication bus 1230 for interconnecting these components. Processor(s) 1224 execute modules, programs and/or instructions stored in the memory 1204 and thereby perform processing operations, including the methods described herein according to some embodiments. In some embodiments, the server 1202 also includes a display 1232 for displaying visualizations (e.g., visualizations or interfaces described above in reference to FIGS. 1-7). In some embodiments, the server 1202 generates displays or visualizations, and transmits the visualization (e.g., as a visual specification) to a client device (e.g., search systems 1240, review/approval systems 1242) for display. Some embodiments of the server 1202 include touch, selection, or other I/O mechanisms coupled to the server 1202 via the I/O subsystem 1228, to process input from users that select (or deselect) visual elements of a displayed visualization. In some embodiments, the client device (or software therein) processes user input and transmits a signal to the server 1202 for processing. Some aspects of the server 1202 (e.g., the modules in the memory 1204) are implemented in one or more client devices, in accordance with some embodiments.

In some embodiments, the memory 1204 stores one or more programs (e.g., sets of instructions), and/or data structures, collectively referred to as “modules” herein. In some embodiments, the memory 1204, or the non-transitory computer readable storage medium of the memory 1204, stores the following programs, modules, and data structures, or a subset or superset thereof:
an operating system 1206;
a query log module 1208 to obtain and/or process query logs 1210, keywords 1212, queries and/or responses 1214, and/or a ranking module 1216 (e.g., a module to rank queries and/or responses based on popularity, frequency, any other user and/or data-driven parameters);
a generative artificial intelligence module 1218 that may include machine language models, such as large language models, data to train and/or test the models, model parameters, hyperparameters, and/or weights;
a semantic aggregation and/or clustering module 1220, an example of which is described below in reference to FIG. 15, according to some embodiments. In some embodiments, clustering is a part of segmentation analysis of similar, disparate queries that may not be semantically adjacent or close but rather are descriptively similar. In some embodiments, cluster identification is trained on documents, queries and/or responses; and
a query and/or response generation module 1222 for generating queries and/or responses based on data and/or output of the query log module 1208, generative artificial intelligence module 1218, semantic aggregation and/or clustering module 1220.

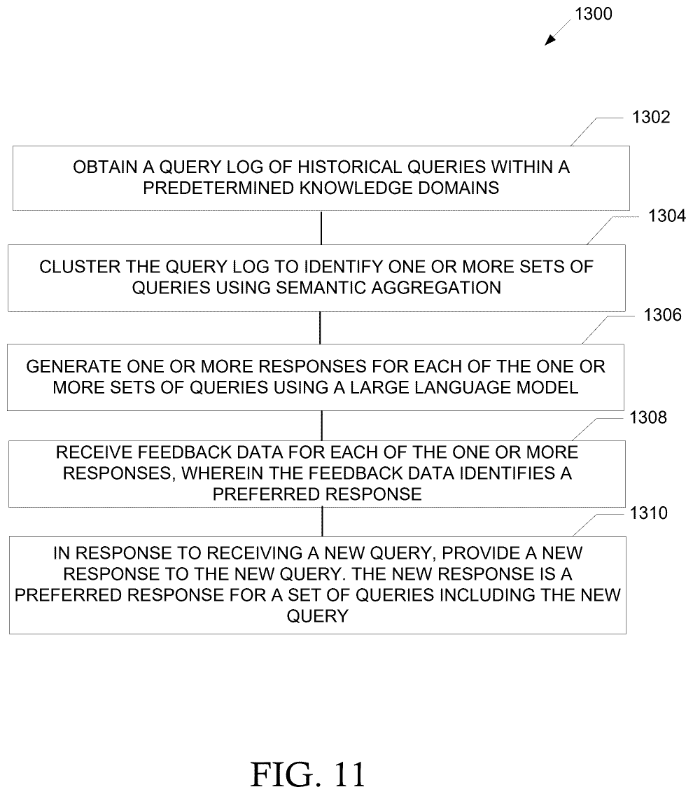

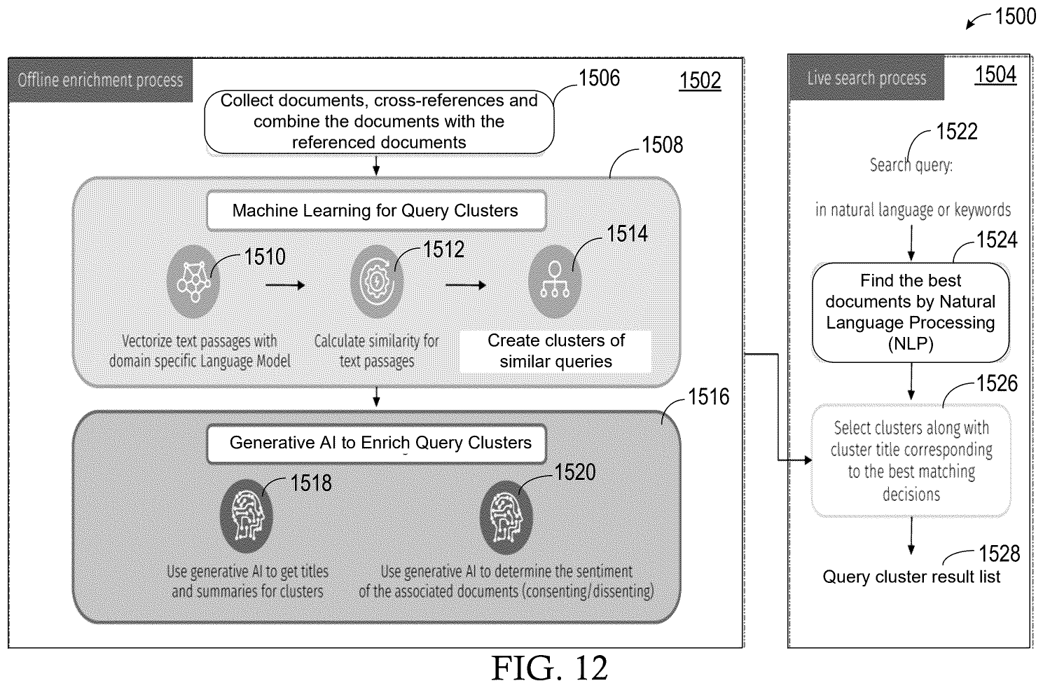

Further details of these modules are described below in reference to FIGS. 11, and FIG. 12, in accordance with some embodiments.

The above identified modules (e.g., data structures, and/or programs including sets of instructions) need not be implemented as separate software programs, procedures, or modules, and thus various subsets of these modules may be combined or otherwise re-arranged in various embodiments. In some embodiments, the memory 1204 stores a subset of the modules identified above. In some embodiments, a database 1234 (e.g., a local database and/or a remote database) stores one or more modules identified above and data associated with the modules. Furthermore, the memory 1204 may store additional modules not described above. In some embodiments, the modules stored in memory 1204, or a non-transitory computer readable storage medium of memory 1204, provide instructions for implementing respective operations in the methods described below. In some embodiments, some or all of these modules may be implemented with specialized hardware circuits that subsume part or all of the module functionality. One or more of the above identified elements may be executed by the one or more of processor(s) 1224.

The I/O subsystem 1228 communicatively couples the server 1202 to one or more devices, such as the content 1238, the search systems 1240, and/or the review/approval systems 1242, via a local and/or wide area communications network 1236 (e.g., the Internet) via a wired and/or wireless connection. The content 1238 may store content for a predetermined knowledge domain. The search systems 1240 may be stand-alone devices (servers or client devices) used to search for content, queries and/or responses. Alternatively, the search system 1240 may be implemented as part of the server 1202. Similarly, the review/approval systems 1242, which may be used to review and/or approve queries and/or responses, may be stand-alone devices or integrated into the server 1202. In some embodiments, the server 1201 pulls data from the content 1238, the search systems 1240 and/or the review approval systems 1242. In other embodiments, the content 1238, the search systems 1240 and/or the review approval systems 1242 push data to the server 1202.

Communication bus 1230 optionally includes circuitry (sometimes called a chipset) that interconnects and controls communications between system components.

FIG. 11 is a flowchart of a method 1300 for automatic query and response generation. The method may be performed by various modules of the server 1200 described above. The method may include obtaining (1302) (e.g., by the query log module 1208) a query log of historical queries within a predetermined knowledge domain. The method may also include clustering (1304) (e.g., by the semantic aggregation and/or clustering module 1220) the query log to identify one or more sets of queries using semantic aggregation. The method may also include generating (1306) one or more responses for each of the one or more sets of queries using a large language model (e.g., using a language model in the generative artificial intelligence module 1218). The responses may be within the predetermined knowledge domain. The method may also include receiving (1308) (e.g., by the query and/or response generation module 12220) feedback data for each of the one or more responses. The feedback data may identify a preferred response. The method may also include in response to receiving a new query, providing (1310) (e.g., by the query and/or response generation module 1222) a new response to the new query. The new response may be a preferred response for a set of queries including the new query.

In some embodiments, the method further includes, prior to receiving feedback data, prioritizing (e.g., by the ranking module 1216) the one or more responses, based on frequency of queries in the query log. In some embodiments, the method further includes, prior to generating one or more responses, prioritizing (e.g., by the ranking module 1216) the one or more sets of queries, based on frequency of queries in the query log.

In some embodiments, the method further includes associating one or more queries with the one or more responses (e.g., by the query and/or response generation module 1222) based on the feedback data.

In some embodiments, the method further includes receiving queries based on keywords (e.g., the keywords 1212) obtained from the one or more sets of queries, and/or generating (e.g., by the module 1222) the one or more responses based on the received queries.

In some embodiments, the method further includes after a first query is selected, preloading (e.g., by the query and/or response generation module 1222) one or more queries related to the first query. The first query may be based on the feedback data. The one or more queries may be generated using a large language model and/or semantic aggregation.

FIG. 12 is a schematic diagram of an example process 1500 for clustering and/or semantic aggregation, in accordance with some embodiments. The process may include an offline enrichment process 1502 and/or a live search process 1504. The offline enrichment process 1502 may include collecting and/or combining (1506) documents and/or (content from) cross-references. The process may also include machine learning for obtaining (1508) query clusters, which may include vectorizing (1510) text passages with domain specific language model, calculating (1512) similarity for text passages, and/or creating (1514) clusters of similar queries. The process 1502 may also include using generative AI (1516) to enrich the query clusters. This step may in turn include using generative AI (1518) to obtain titles and/or summaries for clusters, and/or using generative AI (1520) to determine sentiment of associated documents (e.g., consenting or dissenting opinions). The live search process 1504 may include inputting (1522) search queries in natural language or keywords to identify (1524) documents by natural language processing (NLP), selecting (1526) clusters (e.g., using the process 1502) along with cluster title corresponding to a matching decision (1526), to obtain query cluster result list (1528).

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described implementations. The first widget and the second widget are both widgets, but they are not the same condition unless explicitly stated as such.

The terminology used in the description of the various described implementations herein is for the purpose of describing particular implementations only and is not intended to be limiting. As used in the description of the various described implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen to best explain the principles underlying the claims and their practical applications, to thereby enable others skilled in the art to best use the implementations with various modifications as are suited to the particular uses contemplated.

What is claimed is:

1. A method for automatic query and response generation, the method comprising:
obtaining a query log of historical queries within a predetermined knowledge domain;
clustering the query log to identify one or more sets of queries using semantic aggregation;
generating one or more responses for each of the one or more sets of queries using a large language model, wherein the responses are within the predetermined knowledge domain;
receiving feedback data for each of the one or more responses, wherein the feedback data identifies a preferred response; and
in response to receiving a new query, providing a new response to the new query, wherein the new response is a preferred response for a set of queries including the new query.

2. The method of claim 1, further comprising, prior to receiving feedback data, prioritizing the one or more responses, based on frequency of queries in the query log.

3. The method of claim 1, further comprising, prior to generating one or more responses, prioritizing the one or more sets of queries, based on frequency of queries in the query log.

4. The method of claim 1, further comprising associating one or more queries with the one or more responses based on the feedback data.

5. The method of claim 1, further comprising:
receiving queries based on keywords obtained from the one or more sets of queries; and
generating the one or more responses based on the received queries.

6. The method of claim 1, further comprising highlighting sources used for generating queries for receiving feedback data for each of the one or more responses.

7. The method of claim 1, further comprising, after a first query is selected, preloading one or more queries related to the first query, wherein the first query is based on the feedback data, wherein the one or more queries are generated using a large language model and/or semantic aggregation.

8. A system, comprising:
a non-transitory memory;
a processor communicatively coupled to the non-transitory memory, wherein the processor is configured to read a set of instructions to:
obtain a query log of historical queries within a predetermined knowledge domain;
cluster the query log to identify one or more sets of queries using semantic aggregation;
generate one or more responses for each of the one or more sets of queries using a large language model, wherein the responses are within the predetermined knowledge domain;
receive feedback data for each of the one or more responses, wherein the feedback data identifies a preferred response; and
in response to receiving a new query, provide a new response to the new query, wherein the new response is a preferred response for a set of queries including the new query.

9. The system of claim 8, wherein the processor is further configured to prior to receiving feedback data, prioritize the one or more responses, based on frequency of queries in the query log.

10. The system of claim 8, wherein the processor is further configured to, prior to generate one or more responses, prioritizing the one or more sets of queries, based on frequency of queries in the query log.

11. The system of claim 8, wherein the processor is further configured to associate one or more queries with the one or more responses based on the feedback data.

12. The system of claim 8, wherein the processor is further configured to:
receive queries based on keywords obtained from the one or more sets of queries; and
generate the one or more responses based on the received queries.

13. The system of claim 8, wherein the processor is further configured to highlight sources used for generating queries for receiving feedback data for each of the one or more responses.

14. The system of claim 8, wherein the processor is further configured to after a first query is selected, preload one or more queries related to the first query, wherein the first query is based on the feedback data, wherein the one or more queries are generated using a large language model and/or semantic aggregation.

15. A non-transitory computer-readable medium having instructions stored thereon, wherein the instructions, when executed by at least one processor, cause at least one device to perform operations comprising:
obtaining a query log of historical queries within a predetermined knowledge domain;
clustering the query log to identify one or more sets of queries using semantic aggregation;
generating one or more responses for each of the one or more sets of queries using a large language model, wherein the responses are within the predetermined knowledge domain;
receiving feedback data for each of the one or more responses, wherein the feedback data identifies a preferred response; and
in response to receiving a new query, providing a new response to the new query, wherein the new response is a preferred response for a set of queries including the new query.

16. The non-transitory computer-readable medium of claim 15, wherein the instructions cause the device to perform operations including, prior to receiving feedback data, prioritizing the one or more responses, based on frequency of queries in the query log.

17. The non-transitory computer-readable medium of claim 15, wherein the instructions cause the device to perform operations including, prior to generating one or more responses, prioritizing the one or more sets of queries, based on frequency of queries in the query log.

18. The non-transitory computer-readable medium of claim 15, wherein the instructions cause the device to perform operations including associating one or more queries with the one or more responses based on the feedback data.

19. The non-transitory computer-readable medium of claim 15, wherein the instructions cause the device to perform operations including:
receiving queries based on keywords obtained from the one or more sets of queries; and
generating the one or more responses based on the received queries.

20. The non-transitory computer readable-medium of claim 15, wherein the instructions cause the device to perform operations including highlighting sources used for generating queries for receiving feedback data for each of the one or more responses.
